(19) United States
(12) Patent Application Publication
(10) Pub. No.: US 2025/0274783 A1
(43) Pub. Date: Aug. 28, 2025

(54) METHODS AND APPARATUSES FOR ARTIFICIAL INTELLIGENCE OR MACHINE LEARNING TRAINING

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA); Lei Dong, Shanghai (CN)

(21) Appl. No.: 19/188,770

(22) Filed: Apr. 24, 2025

Related U.S. Application Data
(63) Continuation of application No. PCT/CN2022/127187, filed on Oct. 25, 2022.

(51) Int. Cl. H04W 24/02; H04L 41/16

(52) U.S. Cl. CPC H04W 24/02; H04L 41/16

(57) ABSTRACT

Aspects of the present disclosure provide methods and devices for artificial intelligence or machine learning (AI/ML) model training in a wireless communication network. A first device receives, from a second device, AI/ML model training assistance information and information related to transmission of respective AI/ML model training data, collectively or separately. The first device determines data state information (DSI) of the respective AI/ML model training data based on the AI/ML model training assistance information. The first device transmits, to the second device, the respective AI/ML model training data based on at least one of the DSI of the respective AI/ML model training data or the information related to the transmission of respective AI/ML model training data.

### CROSS-REFERENCE TO RELATED APPLICATION

This application is a continuation of International Application No. PCT/CN2022/127187, entitled “METHODS AND APPARATUSES FOR ARTIFICIAL INTELLIGENCE OR MACHINE LEARNING TRAINING,” filed on Oct. 25, 2022, which is hereby incorporated by reference in its entireties.

### TECHNICAL FIELD

The present disclosure relates to wireless communication generally, and, in particular embodiments, to methods and apparatuses for artificial intelligence or machine learning (AI/ML) training.

### BACKGROUND

Artificial Intelligence technologies may be applied in communication, including artificial intelligence or machine learning (AI/ML) based communication in the physical layer and/or AI/ML based communication in the medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g., to optimize the functionality in the MAC layer.

In some implementations, an AI/ML architecture in a wireless communication network may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning.

However, communications in wireless communications systems, including communications associated with AI/ML model training at multiple nodes, typically occur over non-ideal channels. For example, non-ideal conditions such as electromagnetic interference, signal degradation, phase delays, fading, and other non-idealities may attenuate and/or distort a communication signal or may otherwise interfere with or degrade the communications capabilities of the system.

Conventional AI/ML model training processes generally rely on hybrid automatic repeat request (HARQ) feedback and retransmission processes to try to ensure that data communicated between devices involved in AI/ML model training is successfully received. However, the communication overhead and delay associated with such retransmissions can be problematic.

In addition, the processing capabilities and/or availability of training data for AI/ML training processes may vary significantly between different nodes/devices, which means that the capacity of different nodes to productively participate in an AI/ML model training process may vary significantly. In practice, such disparities often mean that training delays for AI/ML model training processes involving multiple nodes/devices, such as distributed learning or federated learning-based AI/ML model training processes, are dominated by the node/device having the largest delay due to communication delays and/or computation delays.

Therefore, one way to reduce the training delays for AI/ML model training processes may be to minimize communication delays and/or computation delays. These delays can be reduced by utilizing only important data, for example transmitting only important data and/or performing AI/ML model training processes with only important data.

In existing wireless communication systems, e.g., 5G network system, importance of data may be determined based on quality of service (QoS) which is defined in higher layer. For example, the priority in 5G QoS identifier (5QI) may be used to indicate importance of data. For uplink data scheduling, the priority in 5QI is mapped to the priority in logical channel in MAC layer. When a user equipment (UE) performs processes like MAC power distribution unit (PDU) multiplexing and assembly, all selected logical channels are served in a decreasing order of priority. In other words, logical channels with higher priority have higher chances for transmission and therefore would be considered as having higher importance level.

The importance of data defined at higher layer may be associated with a certain data type. Each data type may be regarded as having a certain data importance level. Put another way, each data type is associated with respective data importance level, i.e., different data type indicates different data importance level. As such, the importance of data may be determined based on its data type. However, it is not clear how the data importance should be determined when the data type is the same. This may be a problem especially for the intelligent communication systems in which AI/ML models are deployed, for example 6G network.

For these and other reasons, new methods and devices are desired so that new AI-enabled applications and processes may be implemented while minimizing signaling and communication overhead and delays associated with existing AI/ML model training procedures.

### SUMMARY

There are restrictions in existing artificial intelligence or machine learning (AI/ML) model training processes. For example, as stated above, it is not clear how the data importance should be determined when the data type is the same, which may be a problem especially for the intelligent communication systems in which AI/ML models are deployed, for example 6G wireless network. In the 6G network, a user equipment (UE) may collect AI/ML model training data samples and report the collected samples to the network (e.g., base station (BS)). The AI/ML model training data samples may include measurement at reference signals or sensors (e.g., camera). The source of the AI/ML model training data may be stable. For example, the reference signal is periodically transmitted from the BS. However, the content of the AI/ML training data samples may vary at different time instances. This entails that importance of the AI/ML training data samples may vary at different time instances. For example, importance of the AI/ML training data samples collected at one time instance may be higher than that of other AI/ML training data samples collected at another time instance. However, importance of the AI/ML training data samples cannot necessarily be determined based on the data type, because each AI/ML training data sample may be the same type of data.

In addition, in 6G intelligent communication system, performance of AI/ML model may be determined not only based on inference accuracy but may also be based on the transmission overhead and latency. If a UE transmits all collected AI/ML model training data samples regardless of their data importance levels, huge network resources may be required for transmission of the AI/ML training data, and therefore overall performances of the AI/ML model and the communication system could be degraded.

In existing communication systems (e.g., 5G network), there are several problems with respect to determination or evaluation of data importance. For example, in 5G, the data importance may be determined or evaluated based only on the priority in 5G QoS identifier (5QI) determined in higher layer. However, the data importance cannot be determined in physical layers in 5G. Moreover, as stated above, the notion of data importance is absent for data with the same data type. Without determining the data importance, overall performances of the AI/ML model and the intelligent communication system in 6G could be degraded for example due to huge transmission overhead.

Aspects of the present disclosure provide solutions to overcome at least some of the aforementioned restrictions, for example specific methods and devices for artificial intelligence or machine learning (AI/ML) model training.

According to a first broad aspect of the present disclosure, there is provided herein a method for supporting AI/ML model training in a wireless communication network. The method according to the first broad aspect of the present disclosure may include receiving, by a first device from a second device, AI/ML model training assistance information. The method according to the first broad aspect of the present disclosure may further include determining, by the first device, data state information (DSI) of respective AI/ML model training data based on the AI/ML model training assistance information. The method according to the first broad aspect of the present disclosure may further include receiving, by the first device from the second device, information related to transmission of the respective AI/ML model training data. The method according to the first broad aspect of the present disclosure may further include transmitting, by the first device to the second device, the respective AI/ML model training data based on at least one of the DSI of the respective AI/ML model training data or the information related to transmission of the respective AI/ML model training data.

In some embodiments of the method according to the first broad aspect of the present disclosure, the respective AI/ML model training data is selectively transmitted and the information related to transmission of the respective AI/ML model training data includes a DSI threshold, wherein the processor-executable instructions further comprise processor-executable instructions that, when executed, cause the processor to determine whether the respective AI/ML model training data is to be transmitted to the second device based on the DSI threshold and the DSI of the respective AI/ML model training data.

In some embodiments of the method according to the first broad aspect of the present disclosure, the respective AI/ML model training data is selectively transmitted and the information related to transmission of the respective AI/ML model training data includes information indicative of whether the respective AI/ML model training data is to be transmitted to the second device, wherein the processor-executable instructions further comprise processor-executable instructions that, when executed, cause the processor to transmit, to the second device, at least one of the DSI of the respective AI/ML model training data or AI/ML model training data set information, and to receive, from the second device, the information indicative of whether the respective AI/ML model training data is to be transmitted to the second device.

In some embodiments of the method according to the first broad aspect of the present disclosure, the AI/ML model training data set information includes at least one of: AI/ML model training data set size, or DSI distribution information of the AI/ML model training data set.

In some embodiments of the method according to the first broad aspect of the present disclosure, the AI/ML model training data set information is transmitted using a buffer status report (BSR) or scheduling request (SR).

In some embodiments of the method according to the first broad aspect of the present disclosure, the respective AI/ML model training data is transmitted in accordance with a respective report format determined based on at least one of the DSI of the respective AI/ML model training data or the information related to transmission of the respective AI/ML model training data.

In some embodiments of the method according to the first broad aspect of the present disclosure, wherein the respective report format indicates a respective transmission precision, and a level of the respective transmission precision is determined based on a level of the DSI of the respective AI/ML model training data.

In some embodiments of the method according to the first broad aspect of the present disclosure, wherein the respective report format indicates configuration for the transmission of the respective AI/ML model training data.

In some embodiments of the method according to the first broad aspect of the present disclosure, the configuration for the transmission of the respective AI/ML model training data indicates at least one of resources used for the transmission of the respective AI/ML model training data or a quantization granularity used for the transmission of the respective AI/ML model training data.

In some embodiments of the method according to the first broad aspect of the present disclosure, the respective report format indicates whether the respective AI/ML model training data includes channel state information (CSI) or raw channel information.

In some embodiments of the method according to the first broad aspect of the present disclosure, a relationship between the DSI of the respective AI/ML model training data and the respective report format is configured by the second device.

In some embodiments of the method according to the first broad aspect of the present disclosure, the AI/ML model training assistance information includes at least one of information regarding a reference AI/ML model or at least one reference input data value.

In some embodiments of the method according to the first broad aspect of the present disclosure, the information regarding a reference AI/ML model includes at least one of a reference AI/ML model type, a reference AI/ML model structure, one or more reference AI/ML model parameters, a reference AI/ML model gradient, a reference AI/ML model activation function, a reference AI/ML model input data type, a reference AI/ML model output data type, a reference AI/ML model input data dimension, or a reference AI/ML model output data dimension.

In some embodiments of the method according to the first broad aspect of the present disclosure, determining DSI of respective AI/ML model training data includes inputting the respective AI/ML model training data into the reference AI/ML model and determining the DSI based on output of the reference AI/ML model.

In some embodiments of the method according to the first broad aspect of the present disclosure, the respective AI/ML model training data inputted into the reference AI/ML model replaces the at least one reference input data value.

In some embodiments of the method according to the first broad aspect of the present disclosure, the processor-executable instructions further comprise processor-executable instructions that, when executed, cause the processor to receive, from the second device, updated AI/ML model training assistance information.

In some embodiments of the method according to the first broad aspect of the present disclosure, the DSI of the respective AI/ML model training data includes information indicating at least one of data uncertainty of the respective AI/ML model training data, data importance of the respective AI/ML model training data, degree of requirement of the respective AI/ML model training data for the AI/ML model training, or data diversity of the respective AI/ML model training data.

In some embodiments of the method according to the first broad aspect of the present disclosure, the data uncertainty of the respective AI/ML model training data is determined based on at least one of: entropy, least confidence, margin sampling, or generalization error.

In some embodiments of the method according to the first broad aspect of the present disclosure, the AI/ML model training is at least partly performed by the second device.

In some embodiments of the method according to the first broad aspect of the present disclosure, the respective AI/ML model training data includes at least one of local AI/ML model training data of a local AI/ML model of the first device, or a local gradient associated with the local AI/ML model.

In some embodiments of the method according to the first broad aspect of the present disclosure, the first and second devices cooperate for the AI/ML model training, wherein the processor-executable instructions further comprise processor-executable instructions that, when executed, cause the processor to, before determining the DSI of respective AI/ML model training data, perform part of the AI/ML model training, wherein the respective AI/ML model training data includes respective output of the part of the AI/ML model training.

According to a second broad aspect of the present disclosure, there is provided herein a method for AI/ML model training in a wireless communication network. The method according to the second broad aspect of the present disclosure may include transmitting, by a first device to a second device, AI/ML model training assistance information for use in determining data state information (DSI) of respective AI/ML model training data. The method according to the second broad aspect of the present disclosure may further include transmitting, by the first device to the second device, information related to transmission of the respective AI/ML model training data. The method according to the second broad aspect of the present disclosure may further include receiving, by the first device from the second device, the respective AI/ML model training data, the respective AI/ML model training data being transmitted based on at least one of the DSI of the respective AI/ML model training data or the information related to transmission of the respective AI/ML model training data. The method according to the second broad aspect of the present disclosure may further include performing, by the first device, the AI/ML model training using the respective AI/ML model training data.

In some embodiments of the method according to the second broad aspect of the present disclosure, the respective AI/ML model training data is selectively transmitted and the information related to transmission of the respective AI/ML model training data includes a DSI threshold, wherein the processor-executable instructions further comprise processor-executable instructions that, when executed, cause the processor to configuring the DSI threshold for use in determining whether the respective AI/ML model training data is to be transmitted to the first device.

In some embodiments of the method according to the second broad aspect of the present disclosure, the respective AI/ML model training data is selectively transmitted and the information related to transmission of the respective AI/ML model training data includes information indicative of whether the respective AI/ML model training data is to be transmitted to the first device, wherein the processor-executable instructions further comprise processor-executable instructions that, when executed, cause the processor to receive, from the second device, at least one of the DSI of the respective AI/ML model training data or AI/ML model training data set information, to determine whether the respective AI/ML model training data is to be transmitted to the first device using at least one of the DSI of the respective AI/ML model training data or the AI/ML model training data set information, and to transmit, to the second device, the information indicative of whether the respective AI/ML model training data is to be transmitted to the first device.

In some embodiments of the method according to the second broad aspect of the present disclosure, the AI/ML model training data set information includes at least one of AI/ML model training data set size or DSI distribution information of AI/ML model training data set.

In some embodiments of the method according to the second broad aspect of the present disclosure, the AI/ML model training data set information is transmitted using a buffer status report (BSR) or scheduling request (SR).

In some embodiments of the method according to the second broad aspect of the present disclosure, the respective AI/ML model training data is transmitted in accordance with a respective report format determined based on at least one of the DSI of the respective AI/ML model training data or the information related to transmission of the respective AI/ML model training data.

In some embodiments of the method according to the second broad aspect of the present disclosure, the respective report format indicates a respective transmission precision, and a level of the respective transmission precision is determined based on a level of the DSI of the respective AI/ML model training data.

In some embodiments of the method according to the second broad aspect of the present disclosure, the respective report format indicates configuration for the transmission of the respective AI/ML model training data.

In some embodiments of the method according to the second broad aspect of the present disclosure, the configuration for the transmission of the respective AI/ML model training data indicates at least one of resources used for the transmission of the respective AI/ML model training data or a quantization granularity used for the transmission of the respective AI/ML model training data.

In some embodiments of the method according to the second broad aspect of the present disclosure, the respective report format indicates whether the respective AI/ML model training data includes channel state information (CSI) or raw channel information.

In some embodiments of the method according to the second broad aspect of the present disclosure, the processor-executable instructions further comprise processor-executable instructions that, when executed, cause the processor to configure a relationship between the DSI of the respective AI/ML model training data and the respective report format.

In some embodiments of the method according to the second broad aspect of the present disclosure, the AI/ML model training assistance information includes at least one of information regarding a reference AI/ML model or at least one reference input data value.

In some embodiments of the method according to the second broad aspect of the present disclosure, the information regarding a reference AI/ML model includes at least one of a reference AI/ML model type, a reference AI/ML model structure, one or more reference AI/ML model parameters, a reference AI/ML model gradient, a reference AI/ML model activation function, a reference AI/ML model input data type, a reference AI/ML model output data type, a reference AI/ML model input data dimension, or a reference AI/ML model output data dimension.

In some embodiments of the method according to the second broad aspect of the present disclosure, the processor-executable instructions further comprise processor-executable instructions that, when executed, cause the processor to update the AI/ML model training assistance information, and to transmit, to the second device, the updated AI/ML model training assistance information.

In some embodiments of the method according to the second broad aspect of the present disclosure, the DSI of the respective AI/ML model training data includes information indicating at least one of data uncertainty of the respective AI/ML model training data, data importance of the respective AI/ML model training data, degree of requirement of the respective AI/ML model training data for the AI/ML model training, or data diversity of the respective AI/ML model training data.

In some embodiments of the method according to the second broad aspect of the present disclosure, the DSI of the respective AI/ML model training data is determined based on at least one of: entropy, least confidence, margin sampling, or generalization error.

In some embodiments of the method according to the second broad aspect of the present disclosure, the respective AI/ML model training data includes at least one of local AI/ML model training data of a local AI/ML model of the second device, or a local gradient associated with the local AI/ML model.

In some embodiments of the method according to the second broad aspect of the present disclosure, the first and second devices cooperate for the AI/ML model training such that the first device performs part of the AI/ML model training before determining the DSI of respective AI/ML model training data, the respective AI/ML model training data including respective output of the part of the AI/ML model training.

Corresponding devices are disclosed for performing the methods.

For example, according to another aspect of the disclosure, a device is provided that includes a processor and a memory storing processor-executable instructions that, when executed, cause the processor to carry out a method according to the first broad aspect or the second broad aspect of the present disclosure described above.

According to other aspects of the disclosure, a device including one or more units for implementing any of the method aspects as disclosed in this disclosure is provided. The term “units” is used in a broad sense and may be referred to by any of various names, including for example, modules, components, elements, means, etc. The units may be implemented using hardware, software, firmware or any combination thereof.

By virtue of some aspects of the present disclosure, performance of AI/ML model is enhanced and overfitting phenomenon may be avoided during the AI/ML model training processes. Moreover, transmission overhead (e.g., air interface overhead) may be reduced as less amount of AI/ML model training data samples is transmitted based on data state information (DSI) of the AI/ML model training data. The DSI (e.g., data uncertainty) may be measured at a device (e.g., UE, BS) before the device reports or transmits the AI/ML model training data.

By virtue of some aspects of the present disclosure, for example in federated learning, transmission of AI/ML model training data (e.g., local gradients) that would not contribute to convergence of a global AI/ML model is avoided. As such, signaling overhead in federated learning may be reduced, and the performance of AI/ML model may be improved, and the AI/ML model training may be enhanced.

By virtue of some aspects of the present disclosure, fast convergence of the AI/ML model may be achieved in two-sided AI/ML model training. Extra signaling overhead may be avoided due to the decreased number of transmissions of the AI/ML model training data set.

By virtue of some aspects of the present disclosure, balancing enhanced performance of AI/ML model and reduced transmission overhead may be achieved.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates four EDs communicating with a network device in a communication system, according to embodiments of the present disclosure;

FIG. 6A illustrates and example of a neural network with multiple layers of neurons, according to embodiments of the present disclosure;

FIG. 6B illustrates an example of a neuron that may be used as a building block for a neural network, according to embodiments of the present disclosure;

FIG. 7 illustrates an example of a one-sided AI/ML model training at a base station (BS), according to embodiments of the present disclosure;

FIG. 8A illustrates an example of a reference AI/ML model, according to embodiments of the present disclosure;

FIG. 8B illustrates an example of a reference AI/ML model with reference AI/ML model input data, according to embodiments of the present disclosure;

FIG. 8C illustrates an example of measuring data uncertainty using an AI/ML model for channel information, according to embodiments of the present disclosure;

FIGS. 9A and 9B illustrate example processes of reporting AI/ML model training data from a user equipment (UE) to a BS, according to embodiments of the present disclosure;

FIG. 10 illustrates an example of a one-sided AI/ML model training at a UE, according to embodiments of the present disclosure;

FIGS. 11A and 11B illustrate example processes of reporting AI/ML model training data from a BS to a UE, according to embodiments of the present disclosure;

FIG. 12A illustrates an example of a process of AI/ML model training in federated learning;

FIG. 12B illustrates an example of a process of AI/ML model training in federated learning using data state information (DSI) of AI/ML model training data, according to embodiments of the present disclosure;

FIG. 13 illustrates an example of a two-sided AI/ML model training, according to embodiments of the present disclosure; and

FIG. 14 illustrates an example of an AI/ML model training with data transmission precision adaptation, according to embodiments of the present disclosure; and

FIG. 15 is a flow diagram illustrating an example process for AI/ML model training, according to embodiments of the present disclosure; and

FIG. 16 is a flow diagram illustrating another example process for AI/ML model training, according to embodiments of the present disclosure.

Similar reference numerals may have been used in different figures to denote similar components.

### DETAILED DESCRIPTION

In the present disclosure, “AI/ML Model” refers to a data driven algorithm that applies AI/ML techniques to generate a set of outputs based on a set of inputs.

In the present disclosure, “AI/ML model training” refers to a process to train an AI/ML model by learning the input/output relationship in a data driven manner and obtain the trained AI/ML model for inference.

In the present disclosure, “inference” or “AI/ML inference” refers to a process of using a trained AI/ML model to produce a set of outputs based on a set of inputs.

In the present disclosure, “Federated learning/federated training” refers to a machine learning technique that trains an AI/ML model across multiple decentralized edge nodes (e.g., UEs, gNBs) each performing local model training using local data samples. The technique requires multiple model exchanges, but no exchange of local data samples.

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

### Example Communication Systems and Devices

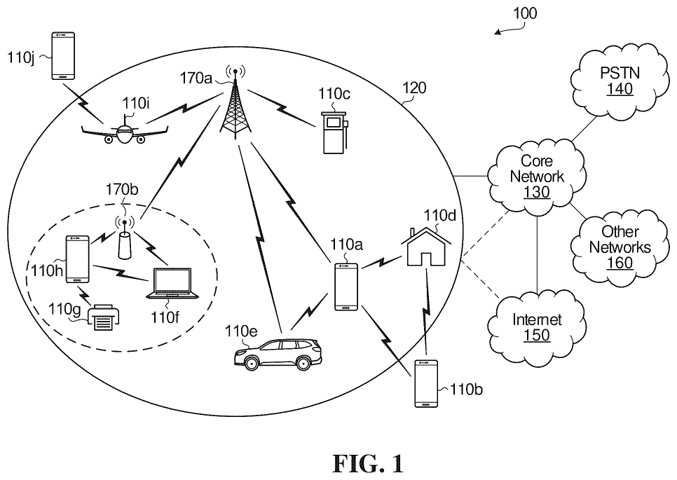

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

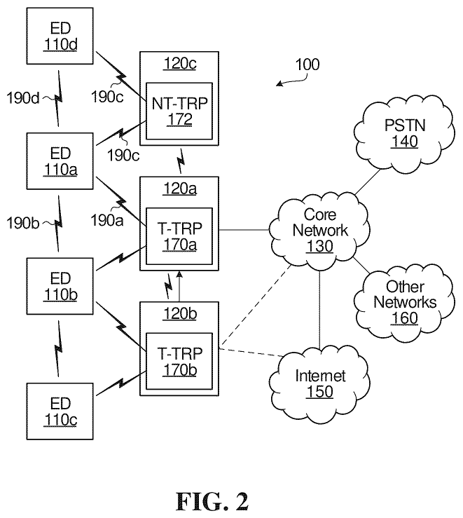

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

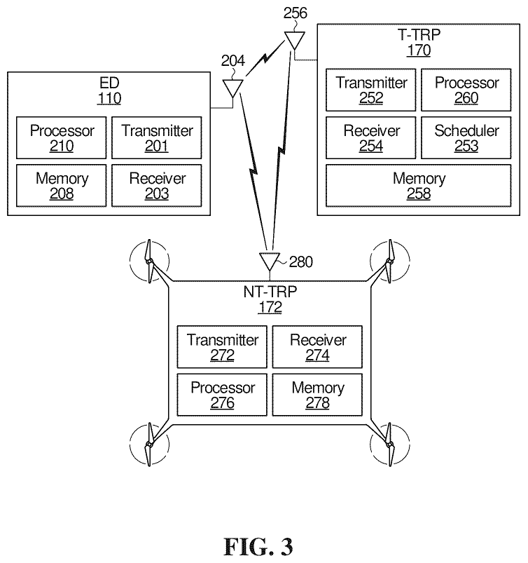

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

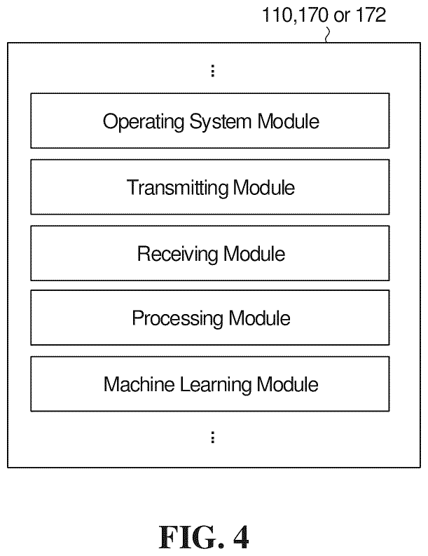

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

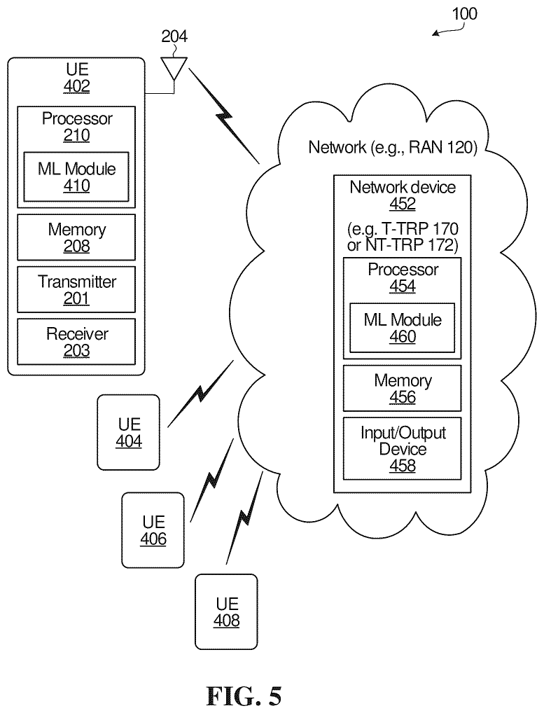

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 452 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc.). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

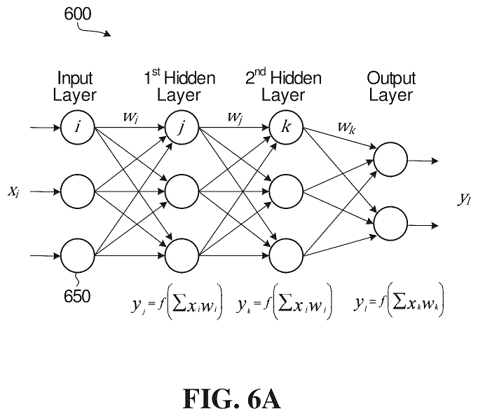

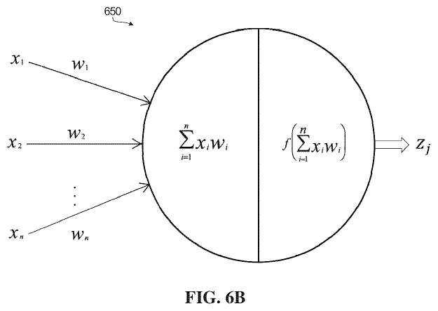

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function f( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 460, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria and the AI/ML model is finalized.

Aspects of the present disclosure provide solutions to overcome at least some of the aforementioned restrictions, for example specific methods and devices for artificial intelligence or machine learning (AI/ML) model training. The methods and devices disclosed in the present disclosure may overcome technical issues related to transmission of AI/ML model training data, such as being unable to determine the relative importance of data of the same data type.

As noted above, one way to reduce the delays for AI/ML model training processes may be to minimize communication delays and/or computation delays. These delays may be reduced by transmitting respective AI/ML model training data based on data importance. The data importance, for example importance of respective AI/ML model training data, may be measured or determined based on data state information (DSI) such as data uncertainty. For example, the data is more important (i.e., higher importance) to an AI/ML model training process if the uncertainty level of the data is higher.

The DSI (e.g., data uncertainty) may be determined at a device, for example but not limited to a user equipment (UE) or a base station (BS), based on AI/ML model training assistance information. The AI/ML model training assistance information may include at least one of information regarding a reference AI/ML model or at least one reference input data value. For example, the information regarding a reference AI/ML model could include a reference AI/ML model type, a reference AI/ML model structure, one or more reference AI/ML model parameters, a reference AI/ML model gradient, a reference AI/ML model activation function, a reference AI/ML model input data type, a reference AI/ML model output data type, a reference AI/ML model input data dimension, and/or a reference AI/ML model output data dimension. The reference input data value(s) may be the respective reference value to be used as input data of the AI/ML model. In some cases, the AI/ML model training assistance information may not include at least one reference input data value, for example when there is only one input data for the AI/ML model or when the device (e.g., UE) has all (multiple) inputs for the AI/ML model.

In some embodiments, a DSI threshold (e.g., uncertainty threshold) may be used to determine whether the respective AI/ML model training data is to be transmitted. For example, only AI/ML model training data whose uncertainty level is higher than the uncertainty threshold may be reported for the AI/ML model training.

In some embodiments, AI/ML model training data set information may be used to determine whether the respective AI/ML model training data is to be transmitted. The AI/ML model training data set information may include AI/ML model training data set size and/or DSI distribution information of the AI/ML model training data set.

A device (e.g., UE, BS) may determine the DSI of respective AI/ML model training data based on the AI/ML model training assistance information. Then, the device may transmit to another device (e.g., UE or BS where the AI/ML model training is performed) the AI/ML model training data based on the DSI of the AI/ML model training data and/or information related to transmission of the AI/ML model training data.

In some embodiments, a device (e.g., UE, BS) may determine the DSI of respective AI/ML model training data in federated leaning. For example, a UE may determine data uncertainty of its local AI/ML model training data (local AI/ML model training data at the UE) before uploading/transmitting local gradients associated with the local AI/ML model to the base station.

In some embodiments with two-sided AI/ML model training, a device (e.g., UE, BS) may determine the DSI of respective AI/ML model training data after at least part of the AI/ML model training is done. For example, there are embodiments where a UE includes an encoder and a reference decoder, a BS includes a decoder, and the UE and the BS perform the AI/ML model training together. In those embodiments, the UE determines data uncertainty of the AI/ML model training data, after the AI/ML model training at the encoder and reference decoder is finished. The respective AI/ML model training data may include respective output of the part of the AI/ML model training (e.g., respective outputs of the encoder and the reference decoder at the UE).

In some embodiments, AI/ML model training data may be transmitted based on the DSI of the respective AI/ML model training data. The AI/ML model training data may be transmitted in accordance with a respective report format which may indicate a respective transmission precision. In one example, a UE may transmit, to a BS, AI/ML model training data having a high data uncertainty level with high precision despite the high transmission overhead this may incur. On the other hand, the UE may transmit, to the BS, AI model training data having a low uncertainty level with low precision to reduce overhead. The relationship between the DSI of the respective AI/ML model training data and respective transmission precision may be configured by the BS in this case.

### One-Sided AI/ML Model Training at BS

According to some embodiments, AI/ML model training data may be transmitted based on importance of AI/ML model training data. The importance of the AI/ML model training data may be measured or determined based on data state information (DSI) of the AI/ML model training data. The DSI may include data uncertainty.

Taking the data uncertainty as an example of the DSI, the AI/ML model training data may be reported or transmitted to another device if the data uncertainty level of the AI/ML model training data is high. AI/ML model training data with high data uncertainty level may be considered more important than AI/ML model training data with low data uncertainty level because the AI/ML model training data with high data uncertainty level may provide more information (i.e., more useful) for AI/ML model training. Moreover, over-fitting phenomena is less likely to occur when the AI/ML model training is performed with the AI/ML model training data with a high data uncertainty level. In contrast, the AI/ML model training data with a low data uncertainty level may be considered less important because such AI/ML model training data may not sufficiently contribute to convergence of the AI/ML model (e.g., little or no contribution for faster convergence of the AI/ML model).

In some embodiments, the AI/ML model training and AI/ML inference may be performed at the BS. For the AI/ML model training and AI/ML inference procedures, the BS may receive AI/ML model training data from one or more UEs. The AI/ML model training data may be generated by each UE. The AI/ML model training may be a one-sided AI/ML model training, as the training is performed only at the BS side.

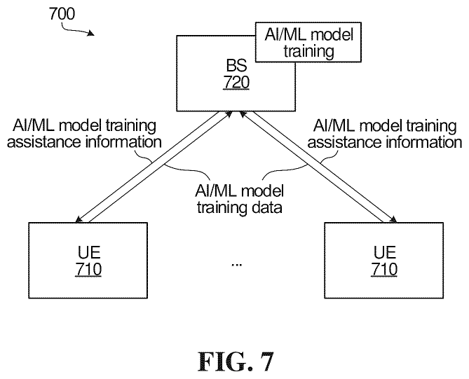

FIG. 7 illustrates an example of a one-sided AI/ML model training at a BS 720 in a wireless network 700, according to embodiments of the present disclosure. Referring to FIG. 7, there are a plurality of UEs 710 and the BS 720 in the network 700. Each UE 710 is communicatively and operatively connected to the BS 720. Each UE 710 may transmit, to the BS 720, AI/ML model training data based on importance of respective AI/ML model training data. In some embodiments, each UE 710 may transmit, to the BS 720, AI/ML model training data in a selective manner based on importance of respective AI/ML model training data. The importance of respective AI/ML model training data may be determined based on DSI of the respective AI/ML model training data, for example data uncertainty of the respective AI/ML model training.

To determine the DSI of the respective AI/ML model training data, each UE 710 may need some assisting information. In some embodiments, this assisting information may be AI/ML model training assistance information provided by the BS 720. Each UE 710 may receive, from the BS 720, the AI/ML model training assistance information. In some embodiments, the UE 710 may receive the AI/ML model training assistance information periodically. In some embodiments, however, the UE 710 may receive the AI/ML model training assistance information aperiodically. Put another way, the BS 720 may not need to transmit the AI/ML model training assistance information before the UE 710 determines the DSI of the respective AI/ML model training data. The UE 710 may determine the DSI of the respective AI/ML model training data using the received AI/ML model training assistance information. The AI/ML model training assistance information may include at least one of information regarding a reference AI/ML model (or query AI/ML model) or at least one reference input data value. The information regarding a reference AI/ML model may include at least one of the following:
a reference AI/ML model type (e.g., convolutional neural networks (CNN), recurrent neural networks (RNN), deep neural networks (DNN));
a reference AI/ML model structure (e.g., the number of layers, the number of neurons for each layer);
one or more reference AI/ML model parameters (e.g., weights, coefficients);
a reference AI/ML model gradient;
a reference AI/ML model activation function (e.g. Sigmoid, Rectified Linear Unit (ReLU), Exponential Linear Unit (ELu), SoftMax);
a reference AI/ML model input data type;
a reference AI/ML model output data type;
a reference AI/ML model input data dimension; or
a reference AI/ML model output data dimension.

To determine the DSI of the respective AI/ML model training data, the UE (e.g., UE 710) may input the respective AI/ML model training data into the reference AI/ML model. The UE may determine the DSI of the respective AI/ML model training data based on the output of the reference AI/ML model into which it inputted the respective AI/ML model training data.

When the DSI of the respective AI/ML model training data is determined, the UE 710 may report or transmit to the BS 720 respective AI/ML model data. The UE 710 may transmit the respective AI/ML model data based on the DSI of the respective AI/ML model training data and/or information related to transmission of the respective AI/ML model training data. For example, the respective AI/ML model training data may be selectively transmitted (e.g., only some of the AI/ML model training data is transmitted while other AI/ML model training data is not transmitted) based on the DSI of the respective AI/ML model training data and/or information related to transmission of the respective AI/ML model training data. The information related to transmission of the respective AI/ML model training data will be discussed below or elsewhere in the present disclosure.

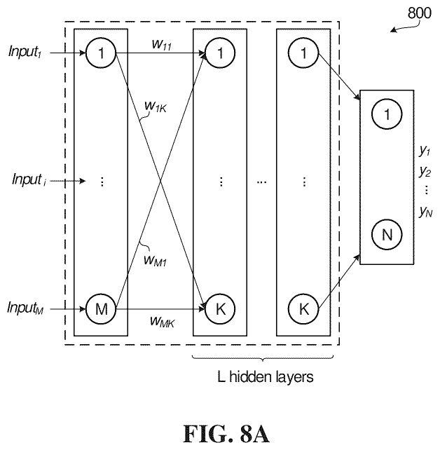

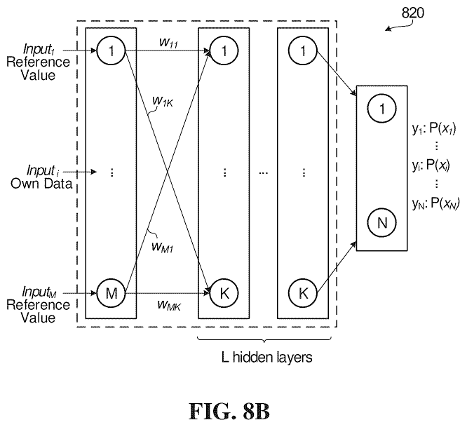

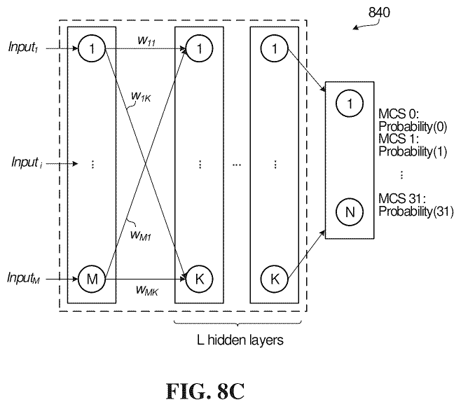

As noted above, the AI/ML model training assistance information, which may be used for determination of the DSI of the respective AI/ML model training data, may include information regarding a reference AI/ML model. FIG. 8A illustrates an example of the reference AI/ML model.

The reference AI/ML model 800 illustrated in FIG. 8A may be implemented using DNN. In other words, the type of the reference AI/ML model 800 may be DNN. The reference AI/ML model input data dimension (i.e., dimension of input data for the reference AI/ML model 800) is M and therefore there are M input data (i.e., Input₁ to Input_{M}). The reference AI/ML model output data dimension (i.e., dimension of output data for the reference AI/ML model 800) is N and therefore there are N output data (i.e. y₁ to y_{N}). The reference AI/ML model 800 may include L hidden layers (i.e., the number of the hidden layers for the reference AI/ML model 800 is L) and each hidden layer includes K neurons (i.e., the number of neuros in each hidden layer is K). The reference AI/ML model 800 may be trained to optimize one or more reference AI/ML model (weight) parameters (e.g., w₁₁, w_{1K}, w_{M1}, w_{MK}). The reference AI/ML model parameters may be determined based on the AI/ML model type (e.g., DNN in this case) and/or the reference AI/ML model structure. The reference AI/ML model activation function may be a predetermined function that is indicated using a preconfigured function index.

In some embodiments, the information regarding a reference AI/ML model may be transmitted from the BS (e.g., BS 720) to the UE (e.g., UE 710) using radio resource control (RRC), medium access control (MAC) control element (MAC-CE), or downlink control information (DCI). The information regarding a reference AI/ML model may be transmitted using broadcast signaling, unicast signaling, or group-cast signaling. In some embodiments, the information regarding a reference AI/ML model may be specific to a UE or a group of UEs/devices. In such cases, the information regarding a reference AI/ML model may be transmitted using unicast signaling or group-cast signaling.

As noted above, the AI/ML model training assistance information, which may be used for determination of the DSI of the respective AI/ML model training data, may also include at least one reference input data value or at least one reference AI/ML model input data. There may be two ways that the BS (e.g., BS 720) transmits the reference AI/ML model input data.

The first way is that the BS (e.g., BS 720) transmits the reference values for all input data of the reference AI/ML model. The UE (e.g., UE 710) may replace part of the received reference values with the local AI/ML model training data, as shown in FIG. 8B which illustrates an example of a reference AI/ML model with reference AI/ML model input data. Specifically, if a UE determining DSI of the respective AI/ML model training data is UEᵢ (e.g., one of the UEs 710), the UEᵢ may replace the i-th reference values with its local AI/ML model training data, and then calculate the output of the reference AI/ML model. In some embodiments, to simplify this process, the reference AI/ML model input data to be replaced by the UEᵢ may be indicated by some predetermined value. For example, the reference AI/ML model input data to be replaced may be filled with zero or one. The UEᵢ may determine the location of reference AI/ML model input data to replace among all the reference data based on the UE index and/or the reference AI/ML model input data dimension (i.e., dimension of the whole reference AI/ML model input data).

The second way is that the BS (e.g., BS 720) transmits the reference values for only some of the reference AI/ML model input data. The UE (e.g., UE 710) may replace the absent reference value (i.e., input data that is not filled with the reference value) with its local AI/ML model training data. Put another way, the UE (e.g., UE 710) may add its local AI/ML model training data as input data of the reference AI/ML model where the input data is not available. The UEᵢ may determine the location of reference AI/ML model input data to add based on the UE index and/or the reference AI/ML model input data dimension (i.e., dimension of the whole reference AI/ML model input data).

In some embodiments, the DSI of the respective AI/ML model training data may include information indicating at least one of: data uncertainty of the respective AI/ML model training data, data importance of the respective AI/ML model training data, degree of requirement of the respective AI/ML model training data for the AI/ML model training, or data diversity of the respective AI/ML model training data.

The data uncertainty of the respective AI/ML model training data may be determined based on at least one of: entropy, least confidence, margin sampling, or generalization error.

In some embodiments where the DSI of the respective AI/ML model training data includes information indicating data uncertainty of the respective AI/ML model training data, the data uncertainty of the respective AI/ML model training data may be determined based on entropy. In such case, the output data of the respective AI/ML model training data may be a function of probability. For example, in FIG. 8B where the AI/ML model 820 is designed to solve some classification problem, the input data is xᵢ (i.e., Inputᵢ) and P(x₁) is the probability that the input data xᵢ belongs to the category i. The entropy of the output for the AI/ML model 820 may be expressed as follows in Equation (1):

H(x)=−Σᵢ₌₁^{N}P(xᵢ)log₂P(xᵢ) (1)

According to the definition of entropy in the above Equation (1), the larger value of H(x) means the higher data uncertainty.

In some embodiments where the DSI of the respective AI/ML model training data includes information indicating data uncertainty of the respective AI/ML model training data, the data uncertainty of the respective AI/ML model training data may be determined based on least confidence. For example, the AI/ML model may not assign a specific class to the respective AI/ML model training data because the AI/ML model (e.g., AI/ML model 820) is not confident with the class membership. Hence, the AI/ML model (e.g., AI/ML model 820) may be trained to select the AI/ML model training data samples that are most informative and uncertain. Put another way, the AI/ML model training data with less confidence in the prediction would be considered as the AI/ML model training data with higher data uncertainty. The margin sampling method may be used when selecting the AI/ML model training data for which the prediction is uncertain (e.g., challenging to predict the class to which the AI/ML model training data belongs). Using the margin sampling method, the AI/ML model training data with minimum distance from the hyper-plane may be the desired AI/ML model training data (e.g., the most uncertain data).

In some embodiments where the DSI of the respective AI/ML model training data includes information indicating data uncertainty of the respective AI/ML model training data, the data uncertainty of the respective AI/ML model training data may be determined based on generalization error (i.e., out-of-sample error). For supervised learning applications in machine learning and statistical learning theory, generalization error may be used to determine how accurately an algorithm is able to predict output values for unprecedented (i.e., previously unseen) or uncertain data.

FIG. 8C illustrates an example of measuring data uncertainty using an AI/ML model 840 for channel information, according to embodiments of the present disclosure. In the example shown in FIG. 8C, the data uncertainty is measured based on entropy, and the AI/ML model is implemented using DNN. The input data of the AI/ML model 840 is channel information, and the output data of the AI/ML model 840 is probability of each MCS index. The AI/ML model 840 aims to provide the probability for each MCS index using the channel information as the input data.

Given that the UEᵢ (not shown in FIG. 8C) is the UE determining data uncertainty of the respective AI/ML model training data, when the UEᵢ takes data i₁ as the Inputᵢ of the AI/ML model 840, the output probabilities for MCS 5 and MCS 7 is 95% and 5%, respectively. If the UEᵢ takes data i₂ as the Inputᵢ of the AI/ML model 840, the output probabilities for MCS 5 and MCS 7 is 51% and 49%, respectively. The output probabilities for the other MCS indices are negligible (i.e., close to zero) for both data i₁ and data i₂, and therefore those output probabilities for the other MCS indices may be ignored in this example. Since the entropy of the data i₂ is greater than that of the data i₁ according to the Equation (1) presented above, the data i₂ provides higher data uncertainty than the data i₂. Therefore, the UEᵢ may report or transmit the data i₂ to the BS to enhance the training of a corresponding AI/ML model at the BS (e.g., AI/ML model training performance improvement).

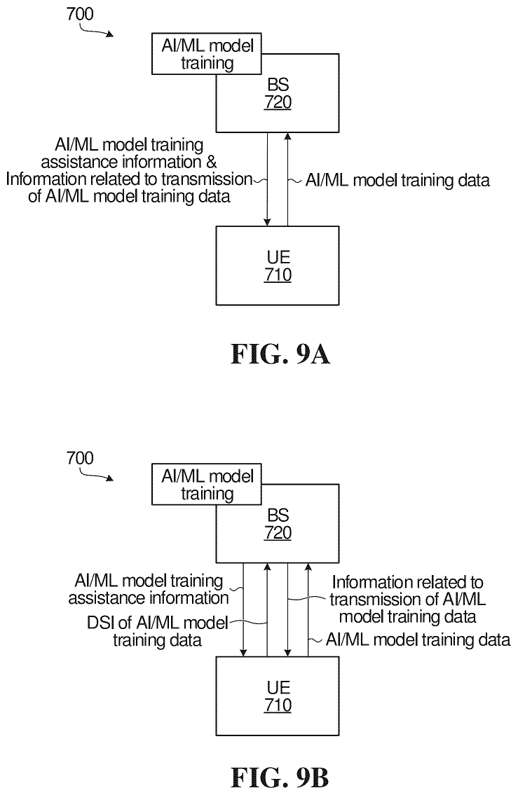

According to some embodiments, after the DSI of the AI/ML model training data is determined, for example using one or more methods illustrated above or elsewhere in the present disclosure, the UE (e.g., UE 710) or the BS (e.g. BS 720) may determine whether the respective AI/ML model training data is to be transmitted to the BS (e.g. BS 720). There may be at least two ways to report the respective AI/ML model training data, as shown in FIGS. 9A and 9B.

FIG. 9A illustrates the first way of reporting the AI/ML model training data in the wireless network 700. In the first way, when the BS 720 transmits the AI/ML model training assistance information, the BS 720 may also transmit information related to transmission of the respective AI/ML model training data. For example, the AI/ML model training assistance information and the information related to transmission of the respective AI/ML model training data may be transmitted (collectively) together. The information related to transmission of the respective AI/ML model training data may include a DSI threshold. In some embodiments where the DSI of the AI/ML model training data includes information indicating data uncertainty of the respective AI/ML model training data, the DSI threshold may be a data uncertainty threshold. The BS 720 may configure or preconfigure the data uncertainty threshold for the UE 710 (e.g., each UE). For each AI/ML model training data, if the data uncertainty of the AI/ML model training data is higher than the data uncertainty threshold received from the BS 720, the UE 710 may transmit the AI/ML model training data to the BS 720 for the AI/ML model training.

In some embodiments, the data uncertainty may be quantified in a form of uncertainty levels (e.g., uncertainty levels ranging from level 0 to level N, N is a positive integer). In this case, the uncertainty threshold may be also quantified in a form of uncertainty levels ranging from level 0 to level N (e.g., uncertainty threshold is level 3).

In the first way of reporting the AI/ML model training data, it may be the UE 710 that determines whether the respective AI/ML model training data is to be transmitted or reported to the BS 720. As illustrated above in the example using the uncertainty threshold, the UE 710 may determine whether the respective AI/ML model training data is to be transmitted or reported to the BS 720 based on the DSI threshold and the DSI of the respective AI/ML model training data.

FIG. 9B illustrates the second way of reporting the AI/ML model training data in the wireless network 700. In the second way, the BS 720 may transmit the AI/ML model training assistance information without the information related to transmission of the respective AI/ML model training data. After receiving the AI/ML model training assistance information, the UE 710 may transmit at least one of the DSI of the respective AI/ML model training data or AI/ML model training data set information may be also transmitted. In some embodiments, the DSI of the respective AI/ML model training data may include information indicating data uncertainty (e.g., uncertainty value, uncertainty level) of the respective AI/ML model training data.

When the BS 720 receives the DSI of the respective AI/ML model training data (e.g., information indicating data uncertainty of the respective AI/ML model training data), the BS 720 may determine whether the respective AI/ML model training data is to be transmitted from the UE 710. Then, the BS 720 may transmit the information related to transmission of the respective AI/ML model training data. In this case, the information related to transmission of the respective AI/ML model training data may include information indicative of whether the respective AI/ML model training data is to be transmitted (reported) to the BS 720. For example, for each AI/ML model training data, if the DSI (e.g., data uncertainty) of the AI/ML model training data satisfies requirements of the AI/ML model and the BS 720 determines the AI/ML model training data is to be reported later, the BS 720 may transmit a permission flag to indicate whether or not the UE 710 is permitted to transmit the AI/ML model training data. For example, if the permission flag is set to “1”, then the UE 710 is allowed to report the AI/ML model training data. Otherwise, the UE 710 is not permitted to report the AI/ML model training data. In some embodiments, the BS 720 may further indicate dynamic uplink transmission resource to be used for transmission/reporting of the AI/ML model training data. In some embodiments, the transmission resource to be used for transmission/reporting of the AI/ML model training data is preconfigured.

As illustrated above, in the second way of reporting the AI/ML model training data, it may be the BS 720 that determines whether the respective AI/ML model training data is to be reported. The determination is made using the DSI of the respective AI/ML model training data (e.g., data uncertainty of the respective AI/ML model training data) and indicated to the UE 710 using, for example, the permission flag.

In some embodiments, the BS 720 may update the AI/ML model training assistance information during the AI/ML model training procedure. In some cases, the BS (e.g., BS 720) may transmit the updated AI/ML model training assistance information to the UE (e.g. UE 710) after the UE determines the DSI of the respective AI/ML model training data. The updated AI/ML model training assistance information may include at least one of information regarding the updated reference AI/ML model (e.g., updated reference AI/ML model parameters), updated reference input data value, or updated DSI threshold (e.g., updated uncertainty threshold). In this way, evolution of the AI/ML model may be properly adapted.

In order to reduce the transmission overhead, only updated reference AI/ML model parameters may be transmitted to the UE, especially when only some of the reference AI/ML model parameters are changed. In some embodiments, the entire reference AI/ML model may be transmitted to the UE if majority of the AI/ML model has been changed (e.g., data uncertainty of majority of AI/ML model training data is higher than the preconfigured uncertainty threshold).

In some embodiments, the BS (e.g., BS 720) may determine whether the respective AI/ML model training data is to be transmitted to the BS using some information received from the UE (e.g., UE 710). For example, the UE may transmit, to the BS, the AI/ML model training data set information which may include at least one of AI/ML model training data set or DSI distribution information of the AI/ML model training data set. The DSI distribution information of the AI/ML model training data set may include a cumulative distribution function (CDF) and/or a probability density function (PDF). The AI/ML model training data set information from each UE may be transmitted with the corresponding DSI (e.g., data uncertainty level) of the respective AI/ML model training data. After receiving at least one of the DSI of the respective AI/ML model training data or the AI/ML model training data set information, the BS may determine whether the respective AI/ML model training data is to be reported. The BS may transmit, to the UE, the information indicative of whether the respective AI/ML model training data is to be transmitted (e.g. permission flag).

In some embodiments, the AI/ML model training data set information may be transmitted using a buffer status report (BSR). For example, the BSR may carry the AI/ML model training data set information by adding one or more extra fields therein. To indicate the CDF or PDF, the value of respective AI/ML model training data may be quantified into N data levels (N is a positive integer). The probabilities of the N data levels may be indicated in accordance with the increasing order of the N data levels.

In some embodiments, transmission of the AI/ML model training data set information may be (implicitly) associated with scheduling request (SR). The relationship between the SR resources and the AI/ML model training data set information may be configured or preconfigured by the BS. In this way, the BS may obtain the AI/ML model training data set information when receiving the SR on the corresponding resources.

### One-Sided AI/ML Model Training at UE

In some embodiments, the AI/ML model training and AI/ML inference may be performed at a UE. For the AI/ML model training and AI/ML inference procedures, the UE may receive AI/ML model training data from a BS. The AI/ML model training data may be generated by the BS. This AI/ML model training may be also a one-sided AI/ML model training, as the training is performed only at the UE side.

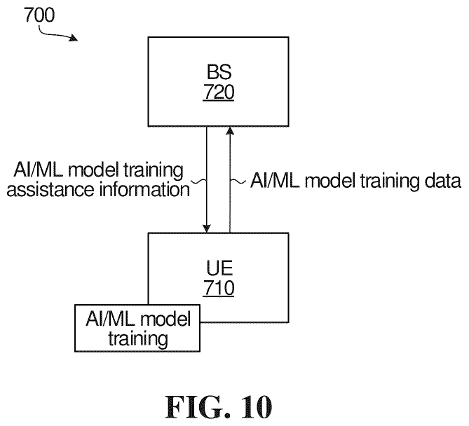

FIG. 10 illustrates an example of a one-sided AI/ML model training at the UE 710 in the wireless network 700, according to embodiments of the present disclosure. Referring to FIG. 10, in the network 700, there is the UE 710 and the BS 720 that are communicatively and operatively connected to each other. The BS 720 may transmit, to the UE 710, AI/ML model training data based on importance of respective AI/ML model training data. In some embodiments, the BS 720 may transmit, to the UE 710, AI/ML model training data in a selective manner based on importance of respective AI/ML model training data. The importance of respective AI/ML model training data may be determined based on DSI of the respective AI/ML model training data, for example data uncertainty of the respective AI/ML model training, as illustrated above or elsewhere in the present disclosure.

Compared to the example illustrated in FIG. 7, in the example illustrated in FIG. 10, both AI/ML model training and AI/ML inference are performed at the UE 710. The UE 710 may transmit AI/ML model training assistance information to the BS 720, and receive the AI/ML model training data from the BS 720. For example, the BS 720 may obtain the uplink (UL) channel information, which may not be directly obtained at the UE 710, using sounding reference signal that is transmitted from the UE 710 to the BS 720. The BS 720 may transmit the obtained UL channel information to the UE 710 as the AI/ML model training data, when the AI/ML model is deployed at the UE 710.

In some embodiments of the one-sided AI/ML model training at UE (e.g., UE 710), a BS (e.g., BS 720) may determine DSI (e.g., data uncertainty) of respective AI/ML model training data. As the respective AI/ML model training data is generated at the BS side, the UE may transmit related AI/ML model training assistance information to the BS using for example RRC, MAC-CE, DCI, broadcast signaling, unicast signaling, and/or group-cast signaling. The AI/ML model training assistance information may include at least one of information regarding a reference AI/ML model or at least one reference input data value. The BS may determine the DSI of the respective AI/ML model training data and transmit the AI/ML model training data to the UE based on the DSI of the respective AI/ML model training data.

The method(s) of determining the DSI of the respective AI/ML model may be substantially same as those for embodiments of the one-sided AI/ML model training at BS (e.g., examples illustrated above and in FIGS. 9A and 9B), except that the roles of the BS and the UE are exchanged.

In some embodiments, the BS may selectively transmit the respective AI/ML model training data. For example, the BS may determine whether or not to report or transmit the respective AI/ML model training data based on the DSI threshold (e.g., uncertainty threshold) received from the UE and the DSI (e.g., data uncertainty) of the respective AI/ML model training data. The manner that the BS determines whether or not to transmit the AI/ML model training data to the UE may be substantially similar to the manner the UE determines in embodiments of the one-sided AI/ML model training at BS (e.g., examples illustrated above and in FIGS. 9A and 9B), except that the roles of the BS and the UE are exchanged.

In some embodiments, the BS may determine whether or not to report or transmit the respective AI/ML model training data based on the information related to transmission of the respective AI/ML model training data received from the UE. The BS may transmit at least one of the DSI of the respective AI/ML model training data or AI/ML model training data set information. Then, the UE may determine whether the respective AI/ML model training data is to be transmitted to the UE and then transmit, to the BS, the information indicative of whether the respective AI/ML model training data should be transmitted to the UE.

In some embodiments, a UE may transmit a request for the AI/ML model training data, for example when the UE needs some AI/ML model training data from the BS. After receiving the AI/ML model training data request, the BS may transmit the AI/ML model training data as illustrated above or elsewhere in the present disclosure.

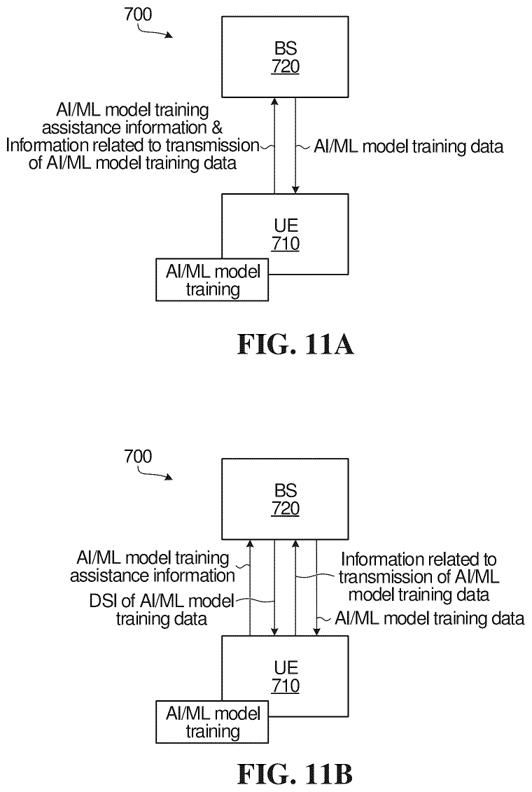

The method(s) of transmission of the respective AI/ML model training data may be substantially the same as those for embodiments of the one-sided AI/ML model training at BS (e.g., examples illustrated above and in FIGS. 9A and 9B), except that the roles of the BS and the UE are exchanged. The examples are shown in FIGS. 11A and 11B illustrating example processes of reporting the respective AI/ML model training data from the BS 720 to the UE 710 in the wireless network 700.

### AI/ML Model Training in Federated Learning

According to some embodiments, the AI/ML model training and AI/ML inference may be performed using a federated learning technique. Federated learning, which is also known as collaborative learning, is a machine learning technique that trains an algorithm across multiple decentralized edge devices or servers. Each decentralized edge device or server holds local data samples but may not exchange with other devices or servers. The federated learning technique is opposite to traditional centralized machine learning techniques in that local data samples are not shared in the federated learning technique whereas all local datasets are uploaded to one server in traditional centralized machine learning techniques.

In wireless federated learning-based (FL-based) AI training processes, a network node/device/node initializes a global AI model, samples a group of user devices, and broadcasts the global AI model parameters to the user devices. Each user device then initializes its local AI model using the global AI model parameters, and updates (trains) its local AI model using its own data. Each user device may then report its updated local AI model's parameters to the network device, which then aggregates the updated parameters reported by the user devices and updates the global AI model. The aforementioned procedure is one iteration of a conventional FL-based AI model training procedure. The network device and the participating user devices typically perform multiple iterations until the AI model has converged sufficiently to satisfy one or more training goals/criteria and the AI model is finalized.

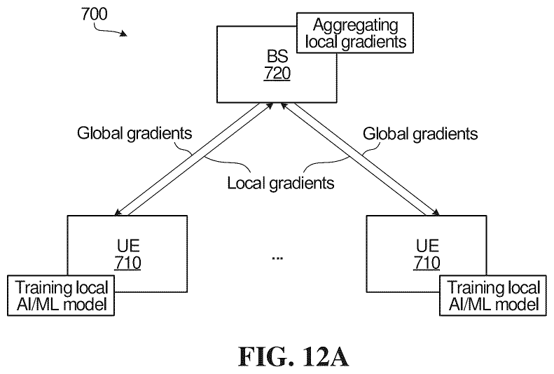

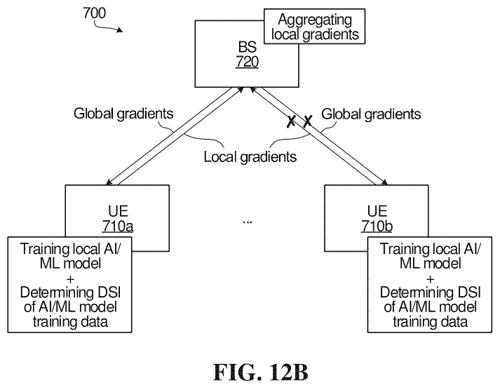

FIG. 12A illustrates an example of a process of AI/ML model training in federated learning in the wireless network 700. During the federated learning, the AI/ML model training may be cooperatively or jointly performed by multiple client devices (e.g., UEs) and one central server device (e.g., BS). The federated learning may be performed for example as illustrated below and FIG. 12A. As shown in FIG. 12A, each of the UEs 710 may train its local AI/ML model with local AI/ML training data. When the training is complete, each UE 710 may update the local gradient associated with its local AI/ML model. Then, each UE 710 may transmit (e.g., upload to the server) the updated local gradient to the BS 720. After receiving the local gradients from each UE 710, the BS 720 may aggregate all of the received local gradients, and generate one or more global gradients associated with the global AI/ML model(s). The BS 720 may transmit (e.g., download to each UEs) the global gradient(s) to each UE 710. The aforementioned procedure may be repeated until the global AI/ML model(s) converges.

In the federated learning procedure, there may be frequent exchange of data (e.g., transmissions of local and global gradients) between the clients (e.g., UEs 710) and the server (e.g., BS 720). This can result in extraordinary transmission overhead.

In order to keep the transmission overhead within an acceptable level, transmissions of gradients for the AI/ML model training should be controlled. To control the transmission of the gradients, the client devices (e.g., UE 710, BS 720) may transmit the local gradients associated with local AI/ML models to the central server based on the DSI of the respective AI/ML model training data. Here, the respective AI/ML model training data may include at least one of local AI/ML model training data of a local AI/ML model of the client device or a local gradient associated with the local AI/ML model.

For example, the UE 710 may determine the DSI (e.g., data uncertainty) of its local AI/ML model training data of its local AI/ML model. If the DSI of the local AI/ML model training data is lower than the DSI threshold (e.g., the data uncertainty of the local AI/ML model training data is lower than the uncertainty threshold, which means the local AI/ML model is relatively stable), the UE 710 may not transmit the local gradient associated with the local AI/ML model (and/or local AI/ML model training data) because the local gradient would not contribute to the AI/ML model training (e.g., convergence of the global AI/ML model). In such cases, the UE 710 may skip transmitting (e.g., uploading) the local gradient associated with the local AI/ML model of the UE 710 in the current iteration.

FIG. 12B illustrates an example of a process of AI/ML model training in federated learning using data state information (DSI) of AI/ML model training data in the wireless network 700.

As shown in FIG. 12B, the UEs 710a and 710b may train their local AI/ML model with their local AI/ML training data. When the trainings are complete, each of the UE 710a and 710b may update the local gradient associated with its local AI/ML model. Each of the UE 710a and 710b may determine the DSI of the respective AI/ML model in the manner illustrated above or elsewhere in the present disclosure. In FIG. 12B, the DSI is data uncertainty, and the data uncertainty of the UE 710a's local AI/ML model training data is higher than the configured or preconfigured uncertainty threshold. As such, the UE 710a may transmit the local gradient associated with its local AI/ML model to the BS 720. On the other hand, the data uncertainty of the UE 710b's local AI/ML model training data is lower than the configured or preconfigured uncertainty threshold. As such, the UE 710b may be prohibited to transmit the local gradient associated with its local AI/ML model to the BS 720. Optionally, the UE 710b may instead transmit an indication to inform the BS 720 that there is no local AI/ML model update in this iteration. The remaining procedure may be substantially similar to the procedure illustrated above and FIG. 12A.

The determination of the DSI of the respective of AI/ML model training data (e.g., local AI/ML model training data) during the federated learning may be performed in the same manner as illustrated above (e.g., embodiments of the one-sided AI/ML model training at BS) or elsewhere in the present disclosure.

### Two-Sided AI/ML Model Training

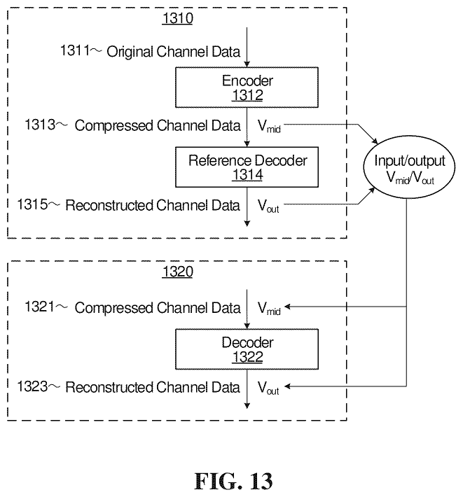

According to some embodiments, the AI/ML model training and AI/ML inference may be performed at both a UE and a BS. In other words, the BS and UE may coordinate to perform the AI/ML model training and AI/ML inference procedures. One example of the two-sided AI/ML model is an auto-encoder for channel state information (CSI) compression, which is illustrated in FIG. 13.

Referring to FIG. 13, the original channel data 1311 (e.g., original channel state information (CSI)) may be generated at the UE 1310. The original channel data 1311 may be conveyed to the CSI encoder 1312 to get the compressed channel data 1313 (e.g., compressed CSI). Due to the compression procedure, some or all of the compressed channel data 1313 may be transmitted to the BS 1320 with lower signaling overhead. The BS 1320 may reconstruct the original channel data (i.e., reconstructed channel data 1323) using the decoder 1322 after receiving the compressed channel data 1321 (e.g., compressed CSI). The compressed channel data 1321 which is inputted into the decoder 1322 may be the same as the compressed channel data 1313 which is outputted from the encoder 1312.

If the UE 1310 trains the encode 1312 and the BS 1320 trains the decoder 1322 (i.e., separately training), the UE 1310 may use a reference decoder 1314 to reconstruct the original channel data and therefore generate the reconstructed channel data 1315. In this way, the divergence between the output of the encoder 1312 (i.e., compressed channel data 1313) and the input of the decoder 1322 (i.e., compressed channel data 1321) may be prevented. The reference decoder 1314 may be configured by the BS 1320 or predefined. In some embodiments, information related to the reference decoder 1314 may be transferred to the UE 1310. In some embodiments, the information related to the reference decoder 1314 or the reference decoder 1314 may be considered as AI/ML model training assistance information.

After the reconstructed channel data 1315 is generated, the UE 1310 may transmit the data set including output of the encoder 1312 (i.e., the compressed channel data 1313 or V_{mid}) and the output of the reference decoder 1314 (i.e., the reconstructed channel data 1315 or Vₒᵤₜ) to the BS 1320. The BS 1320 may train the decoder 1322 with the received data set, where the V_{mid} and Vₒᵤₜ are used as labeled data for training of the decoder 1322 at the BS 1320.

In some embodiments, in order to support faster AI/ML model training (e.g., faster convergence of AI/ML model) and avoid extra signaling overhead, the DSI (e.g., data uncertainty) of the respective AI/ML model training data may be used as one constraining factor when enhancing the two-sided AI/ML model training. For example, the UE 1310 may determine the data uncertainty of the data set including output of the encoder and the output of the reference decoder after the training is finished at the encoder 1312 and reference decoder 1314. If the data uncertainty level of the data set is high, for example higher than the preconfigured uncertainty threshold, the UE 1310 may transmit the data set including output of the encoder 1312 (i.e., the compressed channel data 1313 or V_{mid}) and the reconstructed channel data 1315 (i.e., Vₒᵤₜ) to the BS 1320. In contrast, if the data uncertainty level of data set is low, for example lower than the preconfigured uncertainty threshold, the UE 1310 may not be permitted to transmit the data set to the BS 1320. The UE 1310 may update one or more parameters of the encoder 1312 to obtain a new output (i.e., new compressed channel data 1313 or new V_{mid}) and re-evaluate the data uncertainty of the data set, until the data uncertainty satisfies the requirement (e.g., higher than the preconfigured uncertainty threshold).

The determination of the DSI of the respective of AI/ML model training data (e.g., local AI/ML model training data) for embodiments of the two-sided AI/ML model training may be performed in the same manner as illustrated above (e.g., embodiments of the one-sided AI/ML model training at BS) or elsewhere in the present disclosure.

### AI/ML Model Training Data Transmission Based on Report Format

As noted above, in some embodiments, the respective AI/ML model training data may be selectively transmitted (e.g., some AI/ML model training data is transmitted whereas other AI/ML model training is not transmitted). For example, the respective AI/ML model training data may be transmitted only when the data uncertainty of the AI/ML model training data is greater than the preconfigured uncertainty threshold. Compared to these embodiments, in some other embodiments, all of the respectively AI/ML model training data may be transmitted regardless of the DSI (e.g., data uncertainty) of the respective AI/ML model training data. By transmitting all of the AI/ML model training data, more information would be provided for the AI/ML model training, thereby potentially achieving faster convergence of the AI/ML model. However, such data transmission would result in higher transmission overhead due to transmission of less important AI/ML model training data (e.g. AI/ML model training data with lower data uncertainty).

To achieve a balance between enhanced performance of AI/ML model and reduced transmission overhead, the AI/ML model training data may be transmitted in accordance with a respective report format. In some embodiments, the respective report format may indicate a respective transmission precision, and a level of the respective transmission precision may be determined based on a level of the DSI of the respective AI/ML model training data. In some embodiments, the respective report format may indicate configuration for the transmission of the respective AI/ML model training data.

As noted above, in some embodiments, the respective report format may indicate a respective transmission precision. In other words, the AI/ML model training data may be transmitted based on a respective transmission precision indicated in the respective report format. If some AI/ML model training data has high data uncertainty (i.e., the AI/ML model training data would make larger contribution to the AI/ML model training), the transmission of the AI/ML model training data may be performed with high precision in an effort to guarantee successful transmission of the data. On the other hand, if some AI/ML model training data has low data uncertainty (i.e., the AI/ML model training data would provide limited information and therefore make little contribution to the AI/ML model training), the transmission of the AI/ML model training data may be performed with low precision to reduce the transmission overhead.

In some embodiments, when the respective transmission precision is higher than a predetermined value (e.g., high precision), the respective AI/ML model training data is fully transmitted. In other words, full AI/ML model training data may be transmitted, or raw AI/ML model training data may be transmitted without preprocessing. For example, if the AI/ML model training data is channel information, complete channel information including all of the real and imaginary values may be transmitted when the transmission precision is high. On the other hand, when the respective transmission precision is lower than the predetermined value (e.g., low precision), only part of the respective AI/ML model training data or information extracted from the respective AI/ML model training data is transmitted. For example, if the AI/ML model training data is channel information, the traditional CSI, such as channel quality information (CQI), rank indicator (RI), layer indicator (LI), reference signal received power (RSRP), precoding matrix indicator (PMI), may be transmitted instead of the complete channel information when the transmission precision is low.

In some embodiments, the respective report format may indicate whether the respective AI/ML model training data includes channel state information (CSI) or raw channel information. For raw channel information, the respective report format may indicate, for example, whether to transmit channel information of 6 subcarriers in a resource block (RB) or channel info of 3 subcarriers in an RB.

As noted above, in some embodiments, the respective report format may indicate configuration for the transmission of the respective AI/ML model training data. In other words, the AI/ML model training data may be transmitted based on the configuration for the transmission of the respective AI/ML model training data indicated in the respective report format. The configuration for the transmission of the respective AI/ML model training data may indicate at least one of resources used for the transmission of the respective AI/ML model training data, or a quantization granularity used for the transmission of the respective AI/ML model training data.

In some embodiments, when the respective transmission precision is higher than a predetermined value (e.g., high precision), the respective AI/ML model training data may be transmitted using a higher number of subcarriers per resource block (RB) or a higher number of bits per RB than when the respective transmission precision is lower than the predetermined value (e.g., low precision). Put another way, when the transmission precision is high, more transmission resource may be allocated or lower MCS value may be used for transmission of the respective AI/ML model training data (i.e., larger number of subcarriers, RBs, subbands, symbols, and/or mini-slots for the transmission). On the other hand, when the transmission precision is low, less transmission resource may be allocated or higher MCS value may be used for transmission of the respective AI/ML model training data (i.e., smaller number of subcarriers, RBs, subbands, symbols, and/or mini-slots for the transmission). For example, for high transmission precision, 6 subcarriers per RB may be used for the transmission of the AI/ML model training data and the resource utilization density is ½. However, for low transmission precision, only 2 subcarriers per RB may be used for the transmission of the AI/ML model training data and the resource utilization density is ⅙.

In some embodiments, when the respective transmission precision is higher than a predetermined value (e.g., high precision), the respective AI/ML model training data may be transmitted using fine quantization granularity (e.g., using more bits to represent raw data). On the other hand, when the respective transmission precision is lower than the predetermined value (e.g., low precision), the respective AI/ML model training data may be transmitted using coarse quantization granularity (e.g., using less bits to represent raw data). For example, when the transmission precision is high, 8 bits may be used to represent one complex value (e.g., 4 bits for real part, 4 bits for imaginary part) for the transmission of the AI/ML model training data. When the transmission precision is low, only 4 bits may be used to represent one complex value (e.g., 2 bits for real part, 2 bits for imaginary part) for the transmission of the AI/ML model training data.

In some embodiments, when the respective transmission precision is higher than a predetermined value (e.g., high precision), the AI/ML model training data may be fully transmitted using more transmission resource (e.g., a higher number of subcarriers per RB or a lower number of bits per RB) and/or fine quantization granularity. On the other hand, when the respective transmission precision is lower than a predetermined value (e.g., low precision), only part of the respective AI/ML model training data or information extracted from the respective AI/ML model training data may be transmitted using less transmission resource (e.g., a lower number of subcarriers per RB or a higher number of bits per RB) and/or coarse quantization granularity.

In some embodiments, a relationship between the DSI of the respective AI/ML model training data and the respective report format may be configured by a BS or a device in which the AI/ML training is performed (e.g., UE in which one-sided AI/ML model training is performed).

For example, a BS may configure a relationship between data uncertainty and the corresponding data transmission precision for the AI/ML model training data. The BS may configure mapping tables for data uncertainty and the corresponding data transmission precision for the AI/ML model training data, as shown below in Tables 1-4. Tables 1-4 illustrate how each data uncertainty level may be mapped to the data transmission precision level. In Tables 1-4, the data uncertainty level is ranged from 1 to 8.

Table 1 illustrates the mappings between the data uncertainty level and the data transmission precision level by full/parts data.

TABLE 1

| Data | Data transmission |
|---|---|
| uncertainty | precision level by |
| level | full/parts data |
| 1~2 | Extracting 20% of full data |
| 3~4 | Extracting 40% of full data |
| 5~6 | Extracting 50% of full data |
| 7~8 | Full data |

Table 2 illustrates the mappings between the data uncertainty level and the data transmission precision level by resource granularity.

TABLE 2

| Data | Data transmission |
|---|---|
| uncertainty | precision level by |
| level | resource granularity |
| 1~2 | 2 subcarriers |
| 3~4 | 4 subcarriers |
| 5~6 | 8 subcarriers |
| 7-8 | 12 subcarriers |

Table 3 illustrates the mappings between the data uncertainty level and the data transmission precision level by quantization.

TABLE 3

| Data | Data transmission |
|---|---|
| uncertainty | precision level by |
| level | quantization |
| 1~2 | 2 bits |
| 3~4 | 4 bits |
| 5~6 | 6 bits |
| 7-8 | 8 bits |

Table 4 is the combination of Table 1, Table 2, and Table 3 illustrating the mappings between the data uncertainty level and the data transmission precision level by full/parts data, resource granularity, and quantization.

TABLE 4

| Data | Data transmission | Data transmission | Data transmission |
|---|---|---|---|
| uncertainty | precision level by | precision level by | precision level by |
| level | full/parts data | resource granularity | quantization |
| 1~2 | Extracting 20% of | 2 subcarriers | 2 bits |
| | full data | | |
| 3~4 | Extracting 40% of | 4 subcarriers | 4 bits |
| | full data | | |
| 5~6 | Extracting 50% of | 8 subcarriers | 6 bits |
| | full data | | |
| 7-8 | Full data | 12 subcarriers | 8 bits |

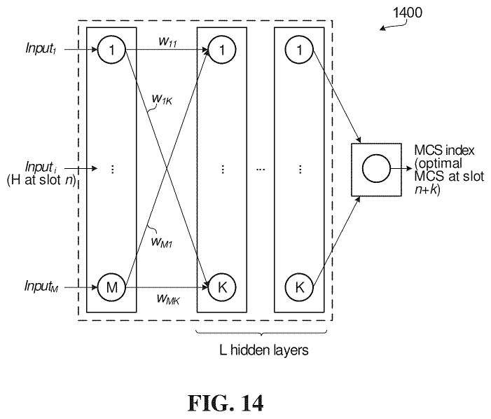

FIG. 14 illustrates an example of an AI/ML model training with data transmission precision adaptation, according to embodiments of the present disclosure. The AI/ML model 1400 illustrated in FIG. 14 may be implemented using DNN. In other words, the type of the AI/ML model 1400 may be DNN. The AI/ML model input data dimension (i.e., dimension of input data for the AI/ML model 1400) is M and therefore there are M input data (i.e., Input₁, to Input_{M}). The AI/ML model output data dimension (i.e., dimension of output data for the AI/ML model 1400) is 1 and therefore there are 1 output data (i.e. the optimal MCS at slot n+k). The AI/ML model 1400 may include L hidden layers (i.e., the number of the hidden layers for the AI/ML model 1400 is L) and each hidden layer includes K neurons (i.e., the number of neuros in each hidden layer is K). The objective of the AI/ML model 1400 is to predict the optimal MCS at slot n+k using the input of historical channel information at slot n (e.g., Inputᵢ) In order to provide more information to assist the AI/ML model training, all of the historical channel information may be permitted to be transmitted. However, to reduce the transmission overheads, the respective AI/ML model training data may be transmitted based on a respective transmission precision indicated in the respective report format. In other words, different transmission precision may be applied to transmission of the respective AI/ML model training data to reduce the transmission overhead.

The determination of the DSI of the respective of AI/ML model training data (e.g., local AI/ML model training data) for embodiments of the two-sided AI/ML model training may be performed in the same manner as illustrated above (e.g., embodiments of the one-sided AI/ML model training at BS) or elsewhere in the present disclosure.

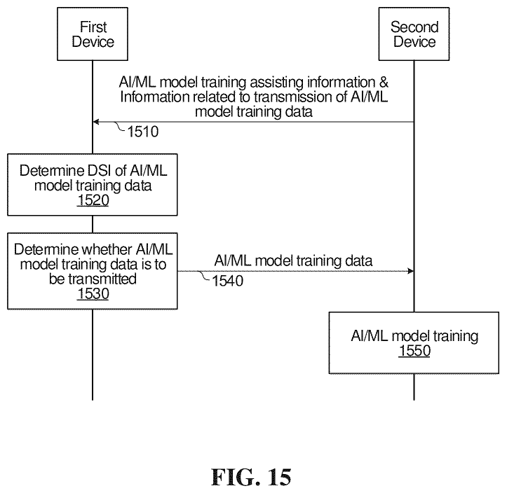

FIG. 15 is a flow diagram illustrating an example process for AI/ML model training in a wireless communication network, according to embodiments of the present disclosure. Referring to FIG. 15, in some embodiments, the first device may be a UE, and the second device may be a BS. In some other embodiments, the first device may be a BS, and the second device may be a UE. In some other embodiments, the first and second devices may be UEs. In some other embodiments, the first and second devices may be BSs.

At step 1510, the first device may receive, from the second device, AI/ML model training assistance information and information related to transmission of the respective AI/ML model training data. In some embodiments, the AI/ML model training assistance information and information related to transmission of the respective AI/ML model training data are transmitted together, for example using one DCI message or sidelink control information (SCI) message. In some embodiments, the AI/ML model training assistance information and the information related to transmission of the respective AI/ML model training data separately. For example, the AI/ML model training assistance information is carried in one DCI or SCI message and the information related to transmission of the respective AI/ML model training data are carried in another DCI or SCI message.

The AI/ML model training assistance information may include at least one of information regarding a reference AI/ML model or at least one reference input data value. The information regarding a reference AI/ML model may include at least one of a reference AI/ML model type, a reference AI/ML model structure, one or more reference AI/ML model parameters, a reference AI/ML model gradient, a reference AI/ML model activation function, a reference AI/ML model input data type, a reference AI/ML model output data type, a reference AI/ML model input data dimension, or a reference AI/ML model output data dimension. In some embodiments, the AI/ML model training assistance information may be updated by the second device. In such cases, the second device may transmit, to the first device, the updated AI/ML model training assistance information.

The information related to transmission of the respective AI/ML model training data may include a DSI threshold. The DSI threshold may be configured by the second device for use in determining whether the respective AI/ML model training data is to be transmitted to the second device.

In some embodiments where the first and second devices cooperate for the AI/ML model training, the first device may perform part of the AI/ML model training before determining the DSI of respective AI/ML model training data at step 1520, and the respective AI/ML model training data may include respective output of the part of the AI/ML model training.

At step 1520, the first device may determine DSI of the respective AI/ML model training data based on the AI/ML model training assistance information.

In some embodiments, the DSI of the respective AI/ML model training data may include information indicating at least one of data uncertainty of the respective AI/ML model training data, data importance of the respective AI/ML model training data, degree of requirement of the respective AI/ML model training data for the AI/ML model training, or data diversity of the respective AI/ML model training data. The data uncertainty of the respective AI/ML model training data may be determined based on at least one of: entropy, least confidence, margin sampling, or generalization error.

In some embodiments, determining DSI of the respective AI/ML model training data may include inputting the respective AI/ML model training data into the reference AI/ML model, and determining the DSI based on output of the reference AI/ML model. The respective AI/ML model training data inputted into the reference AI/ML model may replace the at least one reference input data value.

At step 1530, the first device may determine whether the respective AI/ML model training data is to be transmitted to the second device based on the DSI threshold and the DSI of the respective AI/ML model training data.

At step 1540, the first device may transmit, to the second device, the respective AI/ML model training data based on at least one of the DSI of the respective AI/ML model training data or the information related to transmission of the respective AI/ML model training data.

In some embodiments, the respective AI/ML model training data may be transmitted in accordance with a respective report format determined based on at least one of the DSI of the respective AI/ML model training data or the information related to transmission of the respective AI/ML model training data. In some embodiments, the respective report format may indicate a respective transmission precision, and a level of the respective transmission precision may be determined based on a level of the DSI of the respective AI/ML model training data. In some embodiments, the respective report format may indicate configuration for the transmission of the respective AI/ML model training data. The configuration for the transmission of the respective AI/ML model training data may indicate at least one of resources used for the transmission of the respective AI/ML model training data or a quantization granularity used for the transmission of the respective AI/ML model training data. In some embodiments, the respective report format may indicate whether the respective AI/ML model training data includes channel state information (CSI) or raw channel information. In some embodiments, the second device may configure a relationship between the DSI of the respective AI/ML model training data and the respective report format.

In some embodiments, the respective AI/ML model training data may include at least one of local AI/ML model training data of a local AI/ML model of the first device, or a local gradient associated with the local AI/ML model.

At step 1550, the second device may perform the AI/ML model training using the respective AI/ML model training data. As noted above, in some embodiments, the AI/ML model training is also partly performed by the first device.

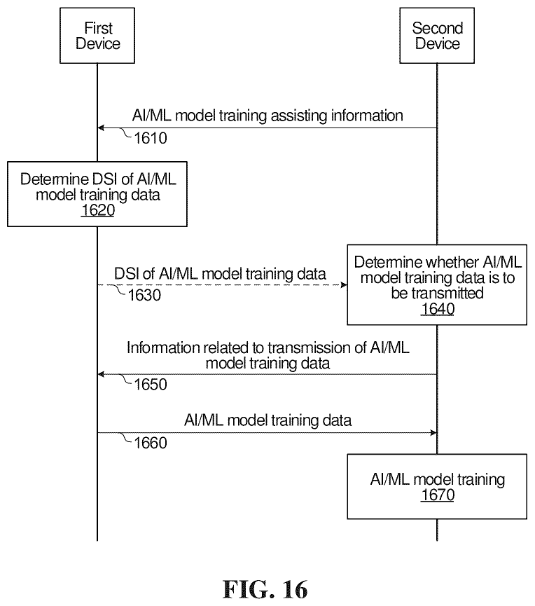

FIG. 16 is a flow diagram illustrating another example process for AI/ML model training in a wireless communication network, according to embodiments of the present disclosure. Referring to FIG. 16, in some embodiments, the first device may be a UE, and the second device may be a BS. In some other embodiments, the first device may be a BS, and the second device may be a UE. In some other embodiments, the first and second devices may be UEs. In some other embodiments, the first and second devices may be BSs.

At step 1610, the first device may receive, from the second device, AI/ML model training assistance information. The AI/ML model training assistance information may include at least one of information regarding a reference AI/ML model or at least one reference input data value. The information regarding a reference AI/ML model may include at least one of a reference AI/ML model type, a reference AI/ML model structure, one or more reference AI/ML model parameters, a reference AI/ML model gradient, a reference AI/ML model activation function, a reference AI/ML model input data type, a reference AI/ML model output data type, a reference AI/ML model input data dimension, or a reference AI/ML model output data dimension. In some embodiments, the AI/ML model training assistance information may be updated by the second device. In such cases, the second device may transmit, to the first device, the updated AI/ML model training assistance information.

In some embodiments where the first and second devices cooperate for the AI/ML model training, before determining the DSI of respective AI/ML model training data at step 1620, the first device may perform part of the AI/ML model training, and the respective AI/ML model training data may include respective output of the part of the AI/ML model training.

At step 1620, the first device may determine DSI of the respective AI/ML model training data based on the AI/ML model training assistance information.

In some embodiments, the DSI of the respective AI/ML model training data may include information indicating at least one of data uncertainty of the respective AI/ML model training data, data importance of the respective AI/ML model training data, degree of requirement of the respective AI/ML model training data for the AI/ML model training, or data diversity of the respective AI/ML model training data. The data uncertainty of the respective AI/ML model training data may be determined based on at least one of: entropy, least confidence, margin sampling, or generalization error.

In some embodiments, determining DSI of the respective AI/ML model training data may include inputting the respective AI/ML model training data into the reference AI/ML model, and determining the DSI based on output of the reference AI/ML model. The respective AI/ML model training data inputted into the reference AI/ML model may replace the at least one reference input data value.

At step 1630, the first device may transmit, to the second device, at least one of the DSI of the respective AI/ML model training data or AI/ML model training data set information. In some embodiments, the AI/ML model training data set information may include at least one of AI/ML model training data set size, or DSI distribution information of AI/ML model training data set. In some embodiments, the AI/ML model training data set information may be transmitted using a buffer status report (BSR) or scheduling request (SR). Step 1630 may be an optional step.

At step 1640, the second device may determine whether the respective AI/ML model training data is to be transmitted to the second device using at least one of the DSI of the respective AI/ML model training data or the AI/ML model training data set information. Step 1640 may be an optional step.

At step 1650, the second device may transmit, to the first device, information related to transmission of the respective AI/ML model training data. The information related to transmission of the respective AI/ML model training data may include information indicative of whether the respective AI/ML model training data is to be transmitted to the second device. Therefore, at step 1650, the second device, may transmit, to the first device, the information indicative of whether the respective AI/ML model training data is to be transmitted to the second device.

At step 1660, the first device may transmit, to the second device, the respective AI/ML model training data based on at least one of the DSI of the respective AI/ML model training data or the information related to transmission of the respective AI/ML model training data.

In some embodiments, the respective AI/ML model training data may be transmitted in accordance with a respective report format determined based on at least one of the DSI of the respective AI/ML model training data or the information related to transmission of the respective AI/ML model training data. In some embodiments, the respective report format may indicate a respective transmission precision, and a level of the respective transmission precision may be determined based on a level of the DSI of the respective AI/ML model training data. In some embodiments, the respective report format may indicate configuration for the transmission of the respective AI/ML model training data. The configuration for the transmission of the respective AI/ML model training data may indicate at least one of resources used for the transmission of the respective AI/ML model training data or a quantization granularity used for the transmission of the respective AI/ML model training data. In some embodiments, the respective report format may indicate whether the respective AI/ML model training data includes channel state information (CSI) or raw channel information. In some embodiments, the second device may configure a relationship between the DSI of the respective AI/ML model training data and the respective report format.

In some embodiments, the respective AI/ML model training data may include at least one of local AI/ML model training data of a local AI/ML model of the first device, or a local gradient associated with the local AI/ML model.

At step 1670, the second device may perform the AI/ML model training using the respective AI/ML model training data. As noted above, in some embodiments, the AI/ML model training is also partly performed by the first device.

The embodiments described above are in the context of UEs communicating with a BS. However, more generally, devices that wirelessly communicate with each other over time-frequency resources need not necessarily be one or more UEs communicating with a BS. For example, two or more UEs may wirelessly communicate with each other over a sidelink using device-to-device (D2D) communication. As another example, two network devices (e.g. a terrestrial base station and a non-terrestrial base station, such as a drone) may wirelessly communicate with each other over a backhaul link. Embodiments are not limited to uplink and/or downlink communication. For example, in the embodiments above, the BS may be substituted with another device, such as a node in the network or a UE. The uplink/downlink communication may instead be sidelink communication. Therefore, as mentioned earlier, the first device might be a UE or a network device (e.g. BS), and the second device might be a UE or a network device (e.g. BS).

By virtue of some aspects of the present disclosure, performance of AI/ML model is enhanced and overfitting phenomenon may be avoided during the AI/ML model training processes. Moreover, transmission overhead (e.g., air interface overhead) may be reduced as less amount of AI/ML model training data samples is transmitted based on data state information (DSI) of the AI/ML model training data. The DSI (e.g., data uncertainty) may be measured at a device (e.g., UE, BS) before the device reports or transmits the AI/ML model training data.

By virtue of some aspects of the present disclosure, for example in federated learning, transmission of AI/ML model training data (e.g., local gradients) that would not contribute to convergence of a global AI/ML model is avoided. As such, signaling overhead in federated learning may be reduced, and the performance of AI/ML model may be improved, and the AI/ML model training may be enhanced.

By virtue of some aspects of the present disclosure, fast convergence of the AI/ML model may be achieved in two-sided AI/ML model training. Extra signaling overhead may be avoided due to the decreased number of transmissions of the AI/ML model training data set.

By virtue of some aspects of the present disclosure, balancing enhanced performance of AI/ML model and reduced transmission overhead may be achieved.

Examples of devices (e.g. ED or UE and TRP or network device) to perform the various methods described herein are also disclosed.

For example, a (first) device may include a memory to store processor-executable instructions, and a processor to execute the processor-executable instructions. When the processor executes the processor-executable instructions, the processor may be caused to perform the method steps of one or more of the devices as described herein, e.g. in relation to FIGS. 7-16. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

AI Artificial intelligence
LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DNN Deep neutral network
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SCI Sidelink control information
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

1. A method, the method comprising:
receiving, by a first device from a second device, artificial intelligence or machine learning (AI/ML) model training assistance information;
determining, by the first device, data state information (DSI) of respective AI/ML model training data based on the AI/ML model training assistance information;
receiving, by the first device from the second device, information related to transmission of the respective AI/ML model training data; and
transmitting, by the first device to the second device, the respective AI/ML model training data based on at least one of the DSI of the respective AI/ML model training data or the information related to the transmission of the respective AI/ML model training data.

2. The method of claim 1, wherein the respective AI/ML model training data is selectively transmitted, the information related to the transmission of the respective AI/ML model training data includes information indicating whether the respective AI/ML model training data is to be transmitted to the second device, and the method further comprises:
transmitting, by the first device to the second device, at least one of the DSI of the respective AI/ML model training data or information of an AI/ML model training data set.

3. The method of claim 2, wherein the information of the AI/ML model training data set indicates at least one of:
a size of the AI/ML model training data set; or
DSI distribution information of the AI/ML model training data set.

4. The method of claim 1, wherein the AI/ML model training assistance information indicates at least one of information regarding a reference AI/ML model or at least one reference input data value.

5. The method of claim 4, wherein the information regarding the reference AI/ML model indicates at least one of:
a reference AI/ML model type;
a reference AI/ML model structure;
one or more reference AI/ML model parameters;
a reference AI/ML model gradient;
a reference AI/ML model activation function;
a reference AI/ML model input data type;
a reference AI/ML model output data type;
a reference AI/ML model input data dimension; or
a reference AI/ML model output data dimension.

6. The method of claim 1, wherein the DSI of the respective AI/ML model training data indicates at least one of:
data uncertainty of the respective AI/ML model training data;
data importance of the respective AI/ML model training data;
degree of requirement of the respective AI/ML model training data; or
data diversity of the respective AI/ML model training data.

7. An apparatus comprising:
at least one processor, coupled with a memory storing processor-executable instructions that, when executed by the at least one processor, cause the apparatus to:
receive, from a second device, artificial intelligence or machine learning (AI/ML) model training assistance information;
determine data state information (DSI) of respective AI/ML model training data based on the AI/ML model training assistance information;
receive, from the second device, information related to transmission of the respective AI/ML model training data; and
transmit, to the second device, the respective AI/ML model training data based on at least one of the DSI of the respective AI/ML model training data or the information related to the transmission of the respective AI/ML model training data.

8. The apparatus of claim 7, wherein the respective AI/ML model training data is selectively transmitted, the information related to the transmission of the respective AI/ML model training data includes information indicating whether the respective AI/ML model training data is to be transmitted to the second device, and the processor-executable instructions, when executed, further cause the apparatus to:
transmit, to the second device, at least one of the DSI of the respective AI/ML model training data or information of an AI/ML model training data set.

9. The apparatus of claim 8, wherein the information of the AI/ML model training data set indicates at least one of:
a size of the AI/ML model training data set; or
DSI distribution information of the AI/ML model training data set.

10. The apparatus of claim 7, wherein the AI/ML model training assistance information indicates at least one of information regarding a reference AI/ML model or at least one reference input data value.

11. The apparatus of claim 10, wherein the information regarding the reference AI/ML model indicates at least one of:
a reference AI/ML model type;
a reference AI/ML model structure;
one or more reference AI/ML model parameters;
a reference AI/ML model gradient;
a reference AI/ML model activation function;
a reference AI/ML model input data type;
a reference AI/ML model output data type;
a reference AI/ML model input data dimension; or
a reference AI/ML model output data dimension.

12. The apparatus of claim 7, wherein the DSI of the respective AI/ML model training data indicates at least one of:
data uncertainty of the respective AI/ML model training data;
data importance of the respective AI/ML model training data;
degree of requirement of the respective AI/ML model training data; or
data diversity of the respective AI/ML model training data.

13. A method, the method comprising:
transmitting, by a first device to a second device, artificial intelligence or machine learning (AI/ML) model training assistance information for use in determining data state information (DSI) of respective AI/ML model training data;
transmitting, by the first device to the second device, information related to transmission of the respective AI/ML model training data;
receiving, by the first device from the second device, the respective AI/ML model training data, the respective AI/ML model training data being transmitted based on at least one of the DSI of the respective AI/ML model training data or the information related to the transmission of the respective AI/ML model training data; and
performing, by the first device, AI/ML model training using the respective AI/ML model training data.

14. The method of claim 13, wherein the respective AI/ML model training data is selectively transmitted, the information related to the transmission of the respective AI/ML model training data includes information indicating whether the respective AI/ML model training data is to be transmitted to the first device, and the method further comprises:
receiving, by the first device from the second device, at least one of the DSI of the respective AI/ML model training data or information of an AI/ML model training data set; and
determining, by the first device, whether the respective AI/ML model training data is to be transmitted to the first device using at least one of the DSI of the respective AI/ML model training data or the information of the AI/ML model training data set.

15. The method of claim 14, wherein the information of the AI/ML model training data set indicates at least one of:
a size of the AI/ML model training data set; or
DSI distribution information of the AI/ML model training data set.

16. The method of claim 13, wherein the AI/ML model training assistance information indicates at least one of information regarding a reference AI/ML model or at least one reference input data value.

17. The method of claim 16, wherein the information regarding the reference AI/ML model indicates at least one of:
a reference AI/ML model type;
a reference AI/ML model structure;
one or more reference AI/ML model parameters;
a reference AI/ML model gradient;
a reference AI/ML model activation function;
a reference AI/ML model input data type;
a reference AI/ML model output data type;
a reference AI/ML model input data dimension; or
a reference AI/ML model output data dimension.

18. The method of claim 13, wherein the DSI of the respective AI/ML model training data indicates at least one of:
data uncertainty of the respective AI/ML model training data;
data importance of the respective AI/ML model training data;
degree of requirement of the respective AI/ML model training data; or
data diversity of the respective AI/ML model training data.

19. An apparatus comprising:
at least one processor, coupled with a memory storing processor-executable instructions that, when executed by the at least one processor, cause the apparatus to:
transmit, to a second device, artificial intelligence or machine learning (AI/ML) model training assistance information for use in determining data state information (DSI) of respective AI/ML model training data;
transmit, to the second device, information related to transmission of the respective AI/ML model training data;
receive from the second device, the respective AI/ML model training data, the respective AI/ML model training data being transmitted based on at least one of the DSI of the respective AI/ML model training data or the information related to the transmission of the respective AI/ML model training data; and
perform AI/ML model training using the respective AI/ML model training data.

20. The apparatus of claim 19, wherein the respective AI/ML model training data is selectively transmitted, the information related to the transmission of the respective AI/ML model training data includes information indicating whether the respective AI/ML model training data is to be transmitted to the apparatus, and the processor-executable instructions, when executed, further cause the apparatus to:
receive, from the second device, at least one of the DSI of the respective AI/ML model training data or information of an AI/ML model training data set; and
determine whether the respective AI/ML model training data is to be transmitted to the apparatus using at least one of the DSI of the respective AI/ML model training data or the information of the AI/ML model training data set.

21. The apparatus of claim 20, wherein the information of the AI/ML model training data set indicates at least one of:
a size of the AI/ML model training data set; or
DSI distribution information of the AI/ML model training data set.

22. The apparatus of claim 19, wherein the AI/ML model training assistance information indicates at least one of information regarding a reference AI/ML model or at least one reference input data value.

23. The apparatus of claim 22, wherein the information regarding the reference AI/ML model indicates at least one of:
a reference AI/ML model type;
a reference AI/ML model structure;
one or more reference AI/ML model parameters;
a reference AI/ML model gradient;
a reference AI/ML model activation function;
a reference AI/ML model input data type;
a reference AI/ML model output data type;
a reference AI/ML model input data dimension; or
a reference AI/ML model output data dimension.

24. The apparatus of claim 19, wherein the DSI of the respective AI/ML model training data indicates at least one of:
data uncertainty of the respective AI/ML model training data;
data importance of the respective AI/ML model training data;
degree of requirement of the respective AI/ML model training data; or
data diversity of the respective AI/ML model training data.
